(19) United States
(12) Patent Application Publication
(10) Pub. No.: US 2019/0086751 A1
(43) Pub. Date: Mar. 21, 2019

(54) Liquid Crystal Display Panel and Array Substrate

(71) Applicant: Shenzhen China Star Optoelectronics Semiconductor Display Technology Co., Ltd., Shenzhen, Guangdong (CN)

(72) Inventor: Sikun Hao, Shenzhen (CN)

(73) Assignee: Shenzhen China Star Optoelectronics Semiconductor Display Technology Co., Ltd., Shenzhen, Guangdong (CN)

(21) Appl. No.: 15/574,226

(22) PCT Filed: Nov. 10, 2017
(86) PCT No.: PCT/CN2017/110323

§ 371 Date: Nov. 15, 2017

(30) Foreign Application Priority Data
Sep. 20, 2017 (CN) 201710849930.8

(51) Int. Cl. G02F 1/1362; G02F 1/1368; G02F 1/1343

(52) U.S. Cl. CPC G02F 1/136286; G02F 1/1368; G02F 1/13439; G02F 2201/40; G02F 2201/123; G02F 2201/121; G02F 1/136209

(57) ABSTRACT

The present disclosure provides an array substrate of a liquid crystal display (LCD) device, where the array substrate includes a first substrate, gate lines, a gate electrode, a gate insulating layer, data lines, a semiconductor active layer, a drain electrode, and a source electrode. The drain electrode is in contact with a first end of the semiconductor active layer, and the source electrode is in contact with a second end of the semiconductor active layer and is connected with an indium tin oxide (ITO) pixel electrode. At least a part of the drain electrode is shared with one of the data lines. A second part of the source electrode extends as a metal light shielding layer.

### BACKGROUND OF THE INVENTION

### 1. Field of the Invention

The present disclosure relates to the field of displays, and more particularly to a liquid crystal display panel and an array substrate.

### 2. Description of the Prior Art

Liquid crystal display (LCD) devices are most widely used flat panel display devices and liquid crystal display devices having high-resolution color screens are gradually being used in a variety of electrical devices, such as mobile phones, personal digital assistants (PDA), digital cameras, computer screens, or notebook computer screens.

Current LCD devices that are widely used comprise an upper substrate, a lower substrate, and a liquid crystal layer arranged between the upper substrate and the lower substrate. The substrate is composed of glass and electrodes. If the upper substrate and the lower substrate both have electrodes, LCD devices in a longitudinal electric field mode can be used, such as a twist nematic (TN) mode, a vertical alignment (VA) mode, and a multi-domain vertical alignment (MVA) mode, where the MVA mode is used to solve narrow viewing angle issues. Other LCD devices are different from the above LCD devices. In the other LCD devices, the electrodes are only arranged on one of the upper substrate and the lower substrate, LCD devices in a horizontal electric field mode can be used, such as an in-plane switching (IPS) mode and a fringe field switching (FFS) mode.

VA mode thin film transistor devices have some advantages, such as a high aperture ratio, high resolution, and wide viewing angles, which are used by large size panels (such as LCD TVs), and a usable ratio of the liquid crystal layer designed by conventional methods is reduced.

From the above, in VA mode LCD devices of the prior art, horseshoe-shaped TFT occupies a large space, further improving width of the horseshoe-shaped TFT in a horizontal direction, reducing aperture ratio of pixels, and reducing optical transmittance of the LCD panel.

### SUMMARY OF THE INVENTION

The aim of the present disclosure is to provide a liquid crystal display (LCD) device and an array substrate capable of improving an aperture ratio of the pixel electrode and increasing optical transmittance of the LCD device.

In order to solve the above issue, the technical scheme of the present disclosure is as follows:

The present disclosure provides an array substrate of a liquid crystal display (LCD) device, where the array substrate comprises:

a first substrate;

gate lines formed on the first substrate;

a gate electrode formed on the first substrate; the gate electrode is connected with the gate lines;

a gate insulating layer formed on the first substrate; the gate insulating layer covers the gate lines and the gate electrode;

data lines formed on the gate insulating layer; the data lines are perpendicular to the gate lines, and the data lines and the gate lines commonly define a pixel region;

a semiconductor active layer formed on the gate insulating layer corresponding to the gate electrode; a sectional width of the semiconductor active layer is less than a sectional width of the gate electrode;

a drain electrode formed on a surface of the gate insulating layer; the drain electrode is in contact with a first end of the semiconductor active layer; and

a source electrode formed on a surface of the gate insulating layer; the source electrode is in contact with a second end of the semiconductor active layer and is connected with an indium tin oxide (ITO) pixel electrode.

At least a part of the drain electrode is shared with the one of data lines, and the one of the data line covers at least a part of the semiconductor active layer. A first part of the source electrode is connected with the ITO pixel electrode and a second part of the source electrode extends as a metal light shielding layer.

According to a preferable embodiment of the present disclosure, an area that the data lines cover the semiconductor active layer is equal to an area of a corresponding part of the drain electrode parallel to the one of the data lines.

According to preferable embodiment of the present disclosure, a longitudinal section of the drain electrode is a horseshoe-shape, and the longitudinal section of the drain electrode is a section parallel to the first substrate. A side of the drain electrode corresponding to the source electrode is a concave of the horseshoe-shape and the source electrode corresponding to the concave of the horseshoe-shape is insulated from the drain electrode.

According to a preferable embodiment of the present disclosure, the first part of the source electrode covers the semiconductor active layer, and the second part of the source electrode extends to a position other than the gate electrode. The second part of the source electrode is a metal light shielding layer shape.

According to a preferable embodiment of the present disclosure, the first part and the second part are on a same layer and are parallel to the data lines.

According to a preferable embodiment of the present disclosure, the array substrate further comprises an indium tin oxide (ITO) common electrode; wherein the ITO common electrode covers a region other than the ITO pixel electrode.

According to a preferable embodiment of the present disclosure, the ITO common electrode covers the switch unit.

The present disclosure further provides a display panel, where the display panel comprises:

a first substrate;

gate lines formed on the first substrate;

a gate insulating layer arranged on the first substrate; the gate insulating layer covers the gate lines;

data lines formed on the gate insulating layer; the data lines are perpendicular to the gate lines, and the data lines and the gate lines commonly define a pixel region;

a thin film transistor (TFT) layer formed on the gate insulating layer; the TFT layer comprises a switch unit;

an indium tin oxide (ITO) pixel electrode formed on the TFT layer;

a liquid crystal layer; and

a second substrate arranged opposite to the first substrate.

The switch unit comprises a drain electrode and a source electrode. At least part of the drain electrode is shared with one of the data lines; a first part of the source electrode is connected with the ITO pixel electrode and a second part of the source electrode extends as a metal light shield layer.

According to a preferable embodiment of the present disclosure, the second substrate comprises a black matrix; and the black matrix covers the data lines and the switch unit.

The present disclosure further provides an array substrate of a liquid crystal display (LCD) device, where the array substrate comprises:

a first substrate

gate lines formed on the first substrate;

a gate electrode formed on the first substrate; the gate electrode is connected with the gate lines;

a gate insulating layer formed on the first substrate; the gate insulating layer covers the gate lines and the gate electrode;

data lines formed on the gate insulating layer; the data lines are perpendicular to the gate lines, and the data lines and the gate lines commonly define a pixel region;

a semiconductor active layer formed on the gate insulating layer corresponding to the gate electrode; a sectional width of the semiconductor active layer is less than a sectional width of the gate electrode;

a drain electrode formed on a surface of the gate insulating layer; the drain electrode is in contact with a first end of the semiconductor active layer; and

a source electrode formed on a surface of the gate insulating layer; the source electrode is in contact with a second end of the semiconductor active layer and is connected with an indium tin oxide (ITO) pixel electrode.

At least a part of the drain electrode is shared with one of the data lines. A first part of the source electrode is connected with the ITO pixel electrode and a second part of the source electrode extends as a metal light shielding layer.

According to a preferable embodiment of the present disclosure, an area that the data lines cover the semiconductor active layer is equal to an area of a corresponding part of the drain electrode parallel to the one of the data lines.

According to preferable embodiment of the present disclosure, a longitudinal section of the drain electrode is a horseshoe-shape, and the longitudinal section of the drain electrode is a section parallel to the first substrate. A side of the drain electrode corresponding to the source electrode is a concave of the horseshoe-shape and the source electrode corresponding to the concave of the horseshoe-shape is insulated from the drain electrode.

According to preferable embodiment of the present disclosure, the first part of the source electrode covers the semiconductor active layer, and the second part of the source electrode extends to a position other than the gate electrode. The second part of the source electrode is a metal light shielding layer shape.

According to preferable embodiment of the present disclosure, a first sliding chute is disposed on the inner side of the first side plate, and the first sliding chute is parallel to a bottom portion of the first side plate.

According to preferable embodiment of the present disclosure, the first part and the second part are on a same layer and are parallel to the data lines.

According to preferable embodiment of the present disclosure, the array substrate further comprises an indium tin oxide (ITO) common electrode; wherein the ITO common electrode covers a region other than the ITO pixel electrode.

According to preferable embodiment of the present disclosure, the ITO common electrode covers the switch unit.

Beneficial effects of the present disclosure are: compared with the LCD pane in prior art, the horseshoe-shaped TFT of the present disclosure uses that the part of the drain electrode is shared with one of the data lines to reduce the width of the horseshoe-shaped TFT in a horizontal direction and occupational area of the horseshoe-shaped TFT. The metal light shielding layer near the TFT of the present disclosure is prepared in the second metal layer, which can shield light and be regarded as the source electrode to turn on the TFT and the pixel electrode. The present disclosure uses the ITO common electrode to cover a region other than the ITO pixel electrode, to greatly reduce capacitive coupling between the array substrate and the color film substrate. The width of the opaque region of the display panel in horizontal direction is reduced, the aperture ratio of the pixels is increased, and optical transmittance of the LCD device is increased through the TFT, the shielding structure, and the ITO common electrode.

### BRIEF DESCRIPTION OF THE DRAWINGS

In order to describe clearly the embodiment in the present disclosure or the prior art, the following will briefly introduce the drawings for the embodiments. Obviously, the following description is only a few embodiments, for a common technical personnel in the field it is easy to acquire some other drawings without creative work.

FIG. 1A-FIG. 1D are structural diagrams of film layers of an array substrate according to an embodiment of the present disclosure.

FIG. 2 is a structural diagram of the pixel in a display panel according to the embodiment of the present disclosure.

### DETAILED DESCRIPTION OF THE PREFERRED EMBODIMENTS

The following description of every embodiment with reference to the accompanying drawings is used to exemplify specific embodiments which may be carried out in the present disclosure. Directional terms mentioned in the present disclosure, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present disclosure. In the drawings, components having similar structures are denoted by same numerals.

The present disclosure can solve the technical issue of a horseshoe-shaped thin film transistor (TFT) occupies a large space, reduced aperture ratio of pixels, and reduced optical transmittance of a liquid crystal display (LCD) panel.

The present disclosure will further be described in detail in accordance with an array substrate and the LCD panel of the figures and the exemplary examples.

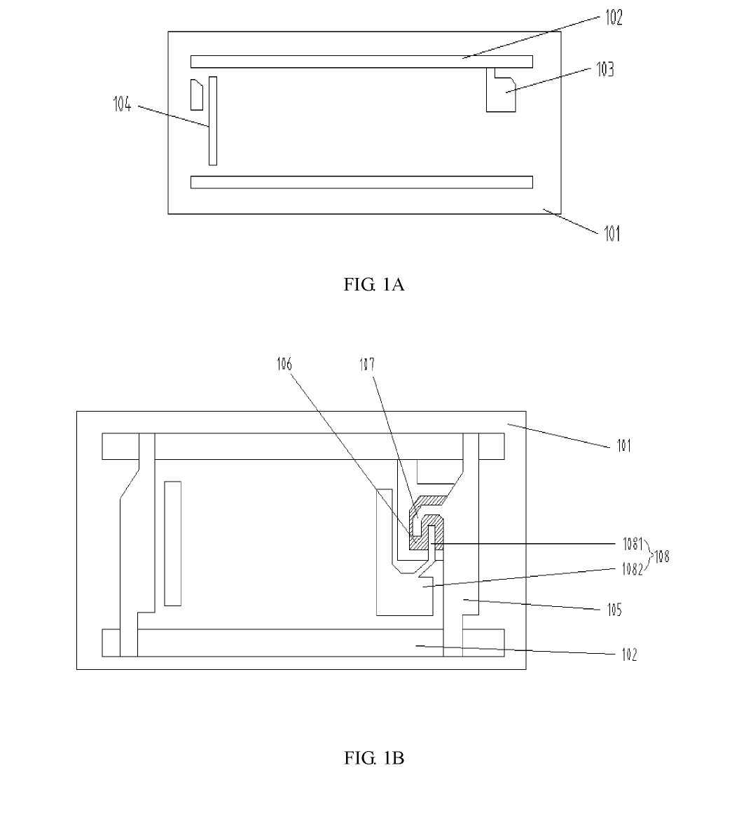

FIG. 1A is a structural diagram of a first metal film layer of an array substrate according to an embodiment of the present disclosure, where the array substrate comprises a first substrate 101, gate lines 102 formed on the first substrate 101, a gate electrode 103 formed on the first substrate 101 and connected with the gate electrode line 102; common electrode lines 104, and a gate insulating layer formed on the first substrate 101. The common electrode lines 104 and the gate lines 102 are prepared on a same layer, and the common electrode lines 104 and the gate lines 102 are arranged at intervals. The gate insulating layer covers the gate lines 102, the gate electrode 103, and the common electrode lines 104.

FIG. 1B is a structural diagram of a second metal film layer of the array substrate according to the embodiment of the present disclosure. The array substrate comprises data lines 105 formed on the gate insulating layer, a semiconductor active layer 106 formed on the gate insulating layer corresponding to the gate electrode 103, a drain electrode 107 formed on a surface of the gate insulating layer, and a source electrode 108 formed on a surface of the gate insulating layer. The data lines 105 are perpendicular to the gate lines 102, and the data lines 105 and the gate lines 102 commonly define a pixel region. A sectional width of the semiconductor active layer 106 is less than a sectional width of the gate electrode 103. The drain electrode 107 is in contact with a first end of the semiconductor active layer 106, and to be specific, the drain electrode 107 is located in a coverage range of the semiconductor active layer 106. The source electrode is in contact with a second end of the semiconductor active layer and is connected with an indium tin oxide (ITO) pixel electrode. At least a part of the drain electrode 107 is shared with one of the data lines 105, and the one of the data line 105 covers at least a part of the semiconductor active layer 106. A longitudinal section of the drain electrode 107 is horseshoe-shaped and the longitudinal section of the drain electrode 107 is a section parallel to the first substrate. An area that the data lines 105 covers the semiconductor active layer 106 is equal to an area of a corresponding part of the drain electrode 107 parallel to the data lines 105. A side of the drain electrode 107 corresponding to the source electrode 108 is a concave of the horseshoe-shape. The source electrode 108 corresponding to the concave of the horseshoe-shape is insulated from the drain electrode 107. A first part 1081 of the source electrode 108 is connected with the ITO pixel electrode. The source electrode 108 extends to form a second part 1082 as a metal light shielding layer. The first part 1081 of the source electrode 108 covers the semiconductor active layer 106, and the second part 1082 of the source electrode 108 extends to a position other than the gate electrode 103. The second part 1082 of the source electrode is a metal light shielding layer shape to shield edge regions of the pixel electrode. The first part 1081 and the second part 1082 are on a same layer, and are parallel to the data lines 105. The drain electrode 107 and the source electrode 108 make the semiconductor active layer 106 form a channel region.

The drain electrode 107, the source electrode 108, and the data lines 105 are regarded as the second metal film layer. At least the part of the drain electrode 107 is shared with one of the data lines 105, and the second part of the source electrode 108 extends as a metal light shielding layer, further simplifying process, reducing time and occupancy ratio of the TFT, and reasonably utilizing space.

FIG. 1C is a structural diagram of a color resistance layer of the array substrate according to the embodiment of the present disclosure. The color resistance layer 109 is prepared on the second metal layer, and a first through-hole 110 is arranged on a position of the color resistance layer 109 corresponding to the source electrode. The first through-hole 110 is used to connect the pixel electrode with the TFT, and a via hole layer is prepared on the color resistance layer 109. A second through-hole is arranged on a position of the via hole layer corresponding to the first through-hole. And a pixel electrode layer is prepared on the via hole layer.

FIG. 1D is a structural diagram of an electrode layer of the array substrate according to the embodiment of the present disclosure. The array substrate comprises an ITO pixel electrode 111, where the ITO pixel electrode 111 comprises a cross-shaped trunk electrode and a plurality of supporting electrodes. The cross-shaped trunk divides the ITO pixel electrode 111 into four regions, and a plurality of supporting electrodes are fishbone-shaped and are connected with the cross-shaped trunk electrode. A first end of the ITO pixel electrode 111 is connected with the source electrode by a second via hole and a first via hole. The second part 1082 of the source electrode 108 covers edges of the ITO pixel electrode 111. An insulating layer is prepared on the ITO pixel electrode 111, and an ITO common electrode 112 is prepared on the insulating layer. The ITO common electrode 112 covers a region other than the ITO pixel electrode and covers the switch unit. The present disclosure uses the ITO common electrode 112 to cover a region other than the ITO pixel electrode, to greatly reduce capacitive coupling between the array substrate and the color film substrate.

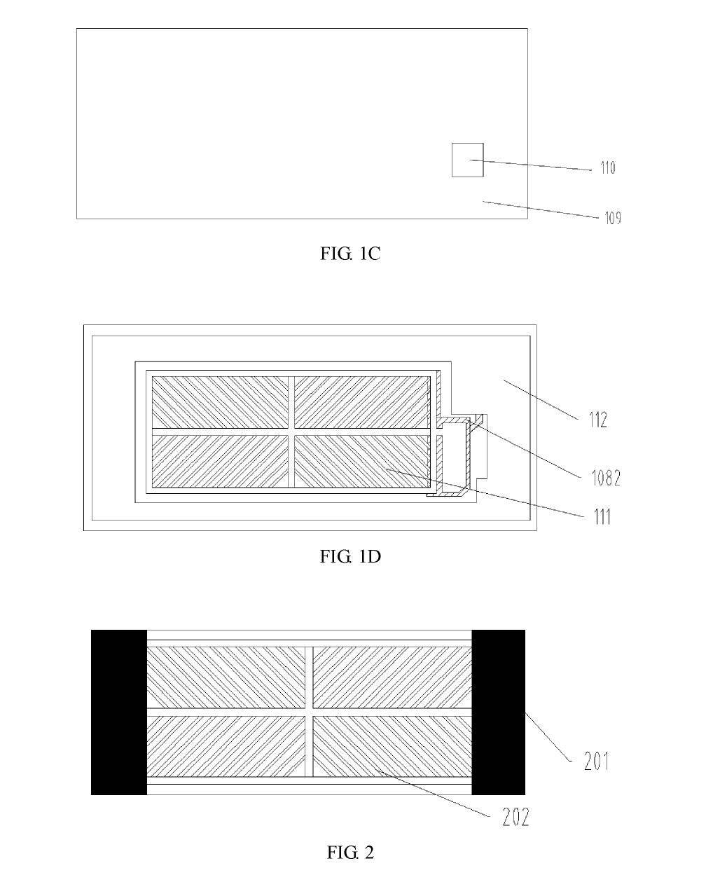

The present disclosure further provides a display panel, where the display panel comprises a first substrate, gate lines formed on the first substrate, a gate insulating layer formed on the first substrate, data lines formed on the gate insulating layer, a thin film transistor (TFT) layer formed on the gate insulating layer, an ITO pixel electrode formed on the TFT layer, a liquid crystal layer, and a second substrate arranged opposite the first substrate. The data lines are perpendicular to the gate lines, and the data lines and the gate lines commonly define a pixel region. The TFT layer comprises a switch unit, where the switch unit comprises a source electrode and a drain electrode. At least a part of the drain electrode is shared with one of the data lines. A first part of the source electrode is connected with the ITO pixel electrode. The source electrode extends to form a second part as a metal light shielding layer. As shown in FIG. 2, the second substrate comprises a black matrix 201, and the black matrix 201 covers the data lines and the switch unit. The black matrix 201 covers a frame region of the ITO pixel electrode and a gap region between two adjacent ITO pixel electrodes. In the embodiment, the gap between the TFT and the data lines is reduced to connect the TFT with the data lines. The part of the drain electrode is shared with the one of the data lines to greatly reduce occupational area of the TFT in a horizontal direction, further reducing shielding area that the black matrix 201 covers the ITO pixel electrode 202, increasing display area of the ITO pixel electrode 202 and aperture ratio, and increasing optical transmittance of the LCD device.

Compared with the LCD pane in prior art, the horseshoe-shaped TFT of the present disclosure uses that the part of the drain electrode is shared with one of the data lines to reduce width of the horseshoe-shaped TFT in a horizontal direction and occupational area of the horseshoe-shaped TFT. The metal light shielding layer near the TFT of the present disclosure is prepared in the second metal layer, which can shield light and be regarded as the source electrode to turn on the TFT and the pixel electrode. The present disclosure uses the ITO common electrode to cover a region other than the ITO pixel electrode, to greatly reduce capacitive coupling between the array substrate and the color film substrate. The width of the opaque region of the display panel in a horizontal direction is reduced, the aperture ratio of the pixels is increased, and optical transmittance of the LCD device is increased through the TFT, shielding structure, and the ITO common electrode.

It should be understood that the present disclosure has been described with reference to certain preferred and alternative embodiments which are intended to be exemplary only and do not limit the full scope of the present disclosure as set forth in the appended claims.

1. An array substrate of a liquid crystal display (LCD) device, comprising:
a first substrate;
gate lines formed on the first substrate;
a gate electrode formed on the first substrate, wherein the gate electrode is connected with the gate lines;
a gate insulating layer formed on the first substrate, wherein the gate insulating layer covers on the gate lines and the gate electrode;
data lines formed on the gate insulating layer, wherein the data lines are perpendicular to the gate lines, and the data lines and the gate lines commonly define a pixel region;
a semiconductor active layer formed on the gate insulating layer corresponding to the gate electrode; wherein a sectional width of the semiconductor active layer is less than a sectional width of the gate electrode; and
a thin film transistor (TFT) layer formed on the gate insulating layer, wherein the TFT layer comprises a switch unit;
wherein the switch unit comprises:
a drain electrode formed on a surface of the gate insulating layer, wherein the drain electrode is in contact with a first end of the semiconductor active layer; and
a source electrode formed on a surface of the gate insulating layer, wherein the source electrode is in contact with a second end of the semiconductor active layer and is connected with an indium tin oxide (ITO) pixel electrode;
wherein at least a part of the drain electrode is shared with one of the data lines, and one of the data line covers at least a part of the semiconductor active layer; a first part of the source electrode is connected with the ITO pixel electrode and a second part of the source electrode extends from the first part of the source electrode as a metal light shielding layer.

2. The array substrate as claimed in claim 1, wherein an area that the one of the data lines cover the semiconductor active layer is equal to an area of a corresponding part of the drain electrode parallel to the data lines.

3. The array substrate as claimed in claim 1, wherein a longitudinal section of the drain electrode is a horseshoe-shape; the longitudinal section of the drain electrode is a section parallel to the first substrate, a side of the drain electrode corresponding to the source electrode is a concave of the horseshoe-shape; the source electrode corresponding to the concave of the horseshoe-shape is insulated from the drain electrode.

4. The array substrate as claimed in claim 3, wherein the first part of the source electrode covers the semiconductor active layer.

5. The array substrate as claimed in claim 4, wherein the first part and the second part are on a same layer and are parallel to the data lines.

6. The array substrate as claimed in claim 1, further comprising an indium tin oxide (ITO) common electrode; wherein the ITO common electrode covers a region other than the ITO pixel electrode.

7. The array substrate as claimed in claim 6, further comprising wherein the ITO common electrode covers the switch unit.

8. A display panel, comprising:
a first substrate;
gate lines formed on the first substrate;
a gate insulating layer arranged on the first substrate; wherein the gate insulating layer covers on the gate lines;
data lines formed on the gate insulating layer, wherein the data lines are perpendicular to the gate lines, and the data lines and the gate lines commonly define a pixel region;
a thin film transistor (TFT) layer formed on the gate insulating layer; wherein the TFT layer comprises a switch unit;
an indium tin oxide (ITO) pixel electrode formed on the TFT layer;
a liquid crystal layer; and
a second substrate arranged opposite to the first substrate;
wherein the switch unit comprises a drain electrode and a source electrode;
wherein at least part of the drain electrode is shared with one of the data lines; a first part of the source electrode is connected with the ITO pixel electrode and a second part of the source electrode extends as a metal light shield layer.

9. The display panel as claimed in claim 8, wherein the second substrate comprises a black matrix; and the black matrix covers the data lines and the switch unit.

10. An array substrate of a liquid crystal display (LCD) device, comprising:
a first substrate;
gate lines formed on the first substrate;
a gate electrode formed on the first substrate, wherein the gate electrode is connected with the gate lines;
a gate insulating layer formed on the first substrate, wherein the gate insulating layer covers on the gate lines and the gate electrode;
data lines formed on the gate insulating layer, wherein the data lines are perpendicular to the gate lines, and the data lines and the gate lines commonly define a pixel region;
a semiconductor active layer formed on the gate insulating layer corresponding to the gate electrode; wherein a sectional width of the semiconductor active layer is less than a sectional width of the gate electrode; and
a thin film transistor (TFT) layer formed on the gate insulating layer; wherein the TFT layer comprises a switch unit;
wherein the switch unit comprises:
a drain electrode formed on a surface of the gate insulating layer, wherein the drain electrode is in contact with a first end of the semiconductor active layer; and
a source electrode formed on a surface of the gate insulating layer, wherein the source electrode is in contact with a second end of the semiconductor active layer and is connected with an indium tin oxide (ITO) pixel electrode;
wherein at least a part of the drain electrode is shared with one of the data lines, a first part of the source electrode is connected with the ITO pixel electrode and a second part of the source electrode extends from the first part of the source electrode as a metal light shielding layer.

11. The array substrate as claimed in claim 10, wherein an area that the data lines covers the semiconductor active layer is equal to an area of a corresponding part of the drain electrode parallel to the one of the data lines.

12. The array substrate as claimed in claim 10, wherein a longitudinal section of the drain electrode is a horseshoe-shape; the longitudinal section of the drain electrode is a section parallel to the first substrate, a side of the drain electrode corresponding to the source electrode is a concave of the horseshoe-shape; the source electrode corresponding to the concave of the horseshoe-shape is insulated from the drain electrode.

13. The array substrate as claimed in claim 3, wherein the first part of the source electrode covers the semiconductor active layer.

14. The array substrate as claimed in claim 13, wherein the first part and the second part are on a same layer and are parallel to the data lines.

15. The array substrate as claimed in claim 10, further comprising an indium tin oxide (ITO) common electrode; wherein the ITO common electrode covers a region other than the ITO pixel electrode

16. The array substrate as claimed in claim 15, wherein the ITO common electrode covers the switch unit.
